(19) United States
(12) Patent Application Publication
(10) Pub. No.: US 2008/0203277 A1
(43) Pub. Date: Aug. 28, 2008

(54) Light Sensitive System and Method for Attenuating the Effect of Ambient Light

(75) Inventors: Yehiel Warszauer, Jerusalem (IL); Pinchas Baksht, Beitar Ilit (IL); Paul Kleinberger, Jerusalem (IL)

Correspondence Address: SUGHRUE MION, PLLC, 2100 PENNSYLVANIA AVENUE, N.W., SUITE 800, WASHINGTON, DC, 20037, US

(73) Assignee: ZAMIR RECOGNITION SYSTEMS, LTD., JERUSALEM (IL)

(21) Appl. No.: 11/916,197

(22) PCT Filed: May 31, 2006
(86) PCT No.: PCT/IL2006/000639

§ 371 Date: Nov. 30, 2007

Related U.S. Application Data
(60) Provisional application No. 60/685,397, filed on May 31, 2005.

(30) Foreign Application Priority Data
May 31, 2006 (IL) 176034

(51) Int. Cl. H01L 27/00

(52) U.S. Cl. 250/208.1

(57) ABSTRACT

There is provided a light-sensitive system responsive to light supplied by the system and less responsive to other light. The system includes a light source operable to supply time-modulated illumination, and a light sensor having greater response to the time-modulated illumination than to light from sources not so modulated. The invention may be embodied as a camera sensitive to supplied light and relatively insensitive to ambient light, and is useful in providing images for automated image interpretation. A method for photographing an object is also provided.

### FIELD OF THE INVENTION

The present invention relates to system and method for photographing objects as they appear when illuminated by a controlled light source, while minimizing influence of ambient light on the resultant images. More particularly, the present invention relates to a system which comprises a camera or a similar device, a rapidly switchable controlled light source, and either a frequency filter or a timing coordinator coordinating operations of the light source with operations of camera light-detection circuitry, to produce an image of an object as illuminated by the controlled light source, which image is largely uninfluenced by ambient light also illuminating the object.

### BACKGROUND OF THE INVENTION

Because the invention described below enables light detection, object detection, and photography which is responsive to light from a controlled light source and is relatively insensitive to natural or artificial ambient light, the invention is particularly useful in the field of automated image interpretation. In images of scenes photographed in natural or other ambient light, the ambient light tends to cast unpredictable reflections and shadows which can seriously complicate image interpretation. The problem is particularly acute when ambient light emanates from moving light sources or when moving objects are illuminated by ambient light. Moreover, sunlight and strong artificial light sources often create strong local reflections (glare) which strongly influence the resultant images and which may erase image details, thereby partially or wholly preventing interpretation of the image. Thus, shadows and light reflections both may erase or confuse details, hide information, and distort forms of objects in an unpredictable manner, seriously complicating the process of image interpretation.

In contrast, when a scene is lit by light supplied by a controlled and constant light source, images of that scene are relatively simple, consistent, and easy to interpret algorithmically.

Another way in which natural ambient lighting can cause problems during forming of images intended for image interpretation is that natural ambient light typically creates large dynamic ranges of light intensities both within images and from image to image, which dynamic ranges extend from powerful reflections of direct sunlight to subtle differences in details nearly hidden in relatively dark shadows. A camera whose shutter speed and/or gain and/or aperture settings are adjusted to deal with light ranging from very bright to very dark (or a sensor similarly adjusted) cannot register fine distinctions in intensity, yet details important for image interpretation are often represented by fine distinctions in intensity. When an automatic camera adjusts to a large dynamic range of intensities, for example, in responding to glare present in part of an image, other portions of the image tend to be “washed out”. Fine details in washed-out portions become difficult or impossible to see, even for a human interpreter.

Even in the somewhat simplified case of image recognition algorithms searching an imaged scene for specific objects having known reflective characteristics when lighted with a known light source (an algorithm searching for license plate numbers on an image of a retro-reflective license-plate, for example), unpredictable strong ambient light can cause the searched object to be erased by superimposed ambient light reflections, or to be washed out, darkened and unrecognizable, when the camera's sensing system, confronted with strong ambient light, automatically changes shutter speed, gain or iris settings to adjust sensitivity (as automatic cameras do) to achieve an overall good image. Thus, the extreme and unpredictable dynamic range of light values presented by ambient-light images constitute yet another reason that images of scenes lit by a controlled artificial light source are typically easier to work with and to interpret than are images lit by unpredictable ambient light.

Thus, for most purposes of automated image interpretation and in many cases of human image interpretation, use of a controlled and consistent artificial light sources simplifies the interpretation process, when compared to the same interpretation processes applied to images created under randomly variable conditions of natural or artificial ambient lighting.

Supplying controlled and consistent lighting when photographing a scene is not difficult. The problem, of course, is that in most circumstances ambient light surrounds us, and existing sensors and cameras cannot ignore it. Thus, it would be highly valuable to have a photography system which not only supplies controlled and consistent lighting, but which is also able to avoid being influenced by natural and artificial ambient light which also illuminates objects being photographed. Light-based sensors similarly independent of influence by changes in ambient light, would similarly be useful to have.

### SUMMARY OF THE INVENTION

The following description is of a system and method capable of sensing light and/or creating photographic images, which system and method provide a controlled light and are responsive to illumination by that controlled light, but partially or wholly unresponsive to illumination by ambient light. In particular, the system and method facilitate image interpretation by enabling controlled-light photography even in brightly lit ambient light conditions. The invention is applicable, inter alia, to CCD and CMOS cameras and the like devices and to individual light detection cells.

The invention also includes a method for photographing an object as illuminated by a controlled light source and for at least partially ignoring ambient light illuminating the object, comprising providing a time-modulated light source and a camera comprising at least one light-sensor which comprises a capacitor, charging the capacitor during first periods and de-charging the capacitor during second periods, and providing light from the controlled light source during the first periods and not providing light from the controlled light source during the second periods.

A further method for photographing an object as illuminated by a controlled light source and at least partially ignoring ambient light illuminating the object comprises providing a time-modulated own light source modulated at a first frequency and a camera comprising at least one light-sensor having electronic circuitry which comprises a capacitor; the camera designed to operate at a frame rate slower than the first frequency; and utilizing a frequency filter to selectively facilitate charging of the capacitor by high frequencies and hinder charging of the capacitor by low frequencies, thereby facilitating charging of the capacitor by frequencies induced in the circuitry in response to light supplied by the time-modulated own light source and hindering charging of the capacitor by frequencies not induced in the circuitry by light from the time-modulated light source.

There is further presented a light-sensitive system responsive to light supplied by the system and less responsive to other light, comprising a light source operable to supply time-modulated illumination, and a light sensor having greater response to the time-modulated illumination than to light from other sources. Embodiments of the system comprise a plurality of light sensors, which may be organized as a pixel array and may be embodied as a digital camera.

Preferably, the light sensor comprises a capacitor and is so constructed that measurement of accumulated charge of the capacitor occurs periodically at a first rate, the light source being operable to be periodically switched on and off at a second rate, wherein the second rate is faster than the first rate.

In preferred embodiments, the light sensor comprises a capacitor and a frequency bypass filter operable to facilitate charging of the capacitor by high frequencies induced in the sensor circuitry, in response to rapidly switched light supplied by the system, and to inhibit charging of the capacitor by lower-frequency currents such as those induced by ambient light.

In particular, the frequency filter is operable to preferentially pass to the charging apparatus of the light sensor harmonic frequencies generated in response to rapidly switched light from the light source, while at least partially restricting passage of currents having frequencies lower than the harmonic frequencies. A frequency filter may be used to ground currents induced by light switched at frequencies inferior to harmonic frequencies generated in response to rapidly switched light from the light source, thereby reducing influence of ambient light on the sensor.

A preferred embodiment of sensor systems preferentially responsive to system-supplied light is a photography system responsive to light supplied by the system and relatively unresponsive to other light, comprising a light source operable to supply time-modulated illumination to a scene, and a camera having time-modulated sensitivity to light, the time-modulation of the supplied light being so coordinated with the time modulation of light sensitivity in the camera that the camera is relatively more sensitive to the time-modulated light than to other light not so modulated.

An additional preferred embodiment of sensor systems preferentially responsive to system-supplied light is a photography system responsive to light supplied by the system and relatively unresponsive to other light, comprising a light source operable to supply rapidly switched time-modulated illumination to a scene, and a camera which comprises a frequency filter which serves to facilitate sensitivity to high frequency currents and to reduce sensitivity to low frequency currents, thereby enhancing sensitivity of the camera to light supplied by the system light source and reduce sensitivity to light from other sources.

The present invention successfully addresses the shortcomings of known configurations by providing a photography system which comprises a controlled light source operable to illuminate a scene with controlled light and a camera module which is responsive to controlled-light illumination yet which is relatively insensitive to ambient light.

Similarly, the present invention successfully addresses the shortcomings of presently known configurations by providing a light sensor sensitive to light from a controlled light source and relatively insensitive to ambient light.

In accordance with the invention there is therefore provided a light sensitive system responsive to light supplied by said system and less responsive to other light, comprising, a) a light source operable to supply time-modulated illumination, and b) a light sensor having greater response to said time-modulated illumination than to light from other sources.

The invention further provides a photography system responsive to light supplied by said system and relatively unresponsive to other light, comprising a) a light source operable to supply time-modulated illumination to a scene, and b) a camera having modulated sensitivity to light, said time-modulation of said supplied light being so coordinated with said modulated light sensitivity that said camera is relatively more sensitive to said time-modulated light than to other light not so modulated.

The invention also provides a photography system responsive to illumination supplied by said system and less responsive to other light, comprising a) a system-controlled light supply, b) a first pixel array of light sensors and a second pixel array of light sensors, c) an optical arrangement which comprises a partially silvered mirror and lens, said optical arrangement serving to focus an image of a scene on both said first pixel array and said second pixel array, d) a timing system serving to coordinate operation of said system such that during first phases of operation said first pixel array is charged and said second pixel array is not charged, and during second phases of operation said second pixel array is charged and said first pixel array is not charged, and said light supply supplies light during said first phases and does not supply light during said second phases, and e) a calculation module operable to calculate a pixilated image based on charge differences between said second array and said first array.

The invention further provides a photography system responsive to illumination supplied by said system and less responsive to other light, comprising a) an interleaved digital camera having a pixel array which comprises first and second sub-arrays of pixels, b) a light source, c) a timing mechanism operable to coordinate supply of light from said light source and frame rate of said interleaved camera in such manner that light is supplied by said light source during charging of said first sub-array of pixels and light is not supplied from said light source during charging of said second sub-array of pixels, and d) a calculation module operable to calculate a difference image based on differences between charges of pixels of said first sub-array and charges of pixels from said second sub-array.

The invention still further provides a method for photographing an object as illuminated by a controlled light source and at least partially ignoring ambient light illuminating said object, comprising a) providing a time-modulated controlled light source and a camera comprising at least one light-sensor which comprises a capacitor, b) charging said capacitor during first periods and de-charging said capacitor during second periods, and c) providing light from said time-modulated controlled light source during said first periods and not providing light from said time-modulated controlled light source during said second periods.

The invention yet further provides A method for producing an photographic image of a scene as illuminated by a controlled light source, comprising focusing an image of said scene on a first pixel array and on a second pixel array, illuminating said scene by said controlled light source during charging of said first pixel array, not illuminating said scene during charging of said second pixel array, and calculating a difference image representing an array of differences between charges of said first array and charges of said second array.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purpose of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is illustrates a photographic system, according to the present invention;

FIG. 2 is a simplified prior art schematic illustration of a light detection cell;

FIG. 3 illustrates a first embodiment of a light-detection cell operable to discharge a capacitor during second phase operation of the system illustrated in FIG. 1, according to the present invention;

FIG. 4 illustrates an alternative construction of a light-detection cell operable to discharge a capacitor during second phase operation of the system illustrated in FIG. 1;

FIG. 5 is a timing diagram summarizing operation of embodiments of the invention illustrated in FIGS. 3 and 4;

FIG. 6 is a schematic illustration of a light-sensitive system using frequency filtration to emphasize sensitivity to rapidly modulated own light and to de-emphasize sensitivity to ambient light, according to an embodiment of the present invention;

FIG. 7 is a schematic illustration of an alternative construction of a of light-sensitive system using frequency filtration to emphasize sensitivity rapidly modulated own light and to de-emphasize sensitivity to ambient light, according to an embodiment of the present invention;

FIG. 8 is a timing and spectrum diagram illustrating aspects of functionality of prior art systems;

FIG. 9 is a timing and spectrum diagram similar to FIG. 8, illustrating aspects of functionality systems shown in FIGS. 6 and 7;

FIG. 10 is a schematic view of a system using a partially silvered mirror to produce photographs sensitive to system-supplied light and relatively insensitive to other light, according to the present invention;

FIG. 11 is a schematic view of an alternative configuration of a system using a partially silvered mirror to produce photographs sensitive to system-supplied light and relatively insensitive to other light, according to the present invention, and

FIG. 12 is a schematic view of a system using an interleaved camera to produce photographs sensitive to system-supplied light and relatively insensitive to other light, according to the present invention.

### DETAILED DESCRIPTION OF THE PREFERRED EMBODIMENTS

The present invention relates to a system and method for photographing objects as they appear when illuminated by a controlled light source, while minimizing influence of ambient light on the resultant images. Specifically, the present invention relates to a system which comprises a camera and a rapidly switched controlled light source, and which uses frequency filtering and/or coordinated switching of supplied light and of light detection processes to render the camera's light-sensitive input circuitry responsive to light originating from the controlled light source, and relatively unresponsive to light originating from other light sources.

To enhance clarity of the following descriptions, the terms “own light” and “camera” will now be defined:

Embodiments of the present invention comprise a light source and a sensor or camera. The phrase “own light” is used hereinbelow to refer to light originating in such a light source. “Own light” may be supplied by a LED or any other controlled light source able to provide short light pulses of controlled length. Generally, light pulses of constant or nearly-constant strength will also be preferred. It is generally preferable that the own light source have a known and constant positional relationship to the sensor or camera. Although in most embodiments multiple periodically repeating light pulses will be used, few or even a single light flash may be “own light” within the meaning of that term, as referred to herein.

The term “camera” is to be understood to include any apparatus operable to create digital still or “motion picture” photographs. The term “camera” is also used herein to refer to any form of light-sensitive sensor. Cameras are, of course, different from light sensors, yet each pixel of a digital camera may be thought of as an individual light sensor. Hence, devices and methods disclosed herein may be applied to individual light-sensing cells, as well as to the array of such cells found in a digital camera. For simplicity of presentation, the term “camera” is used herein to refer both to digital cameras comprising an array of light-sensitive cells, and to light sensors comprising one or more individual light-sensitive cells. References herein to a “cell” may be read as referring to an individual sensor and/or as referring to one of an array of sensors, such as an array of camera pixels. A reader skilled in the art will easily extend design ideas presented herein with reference to such an array of cells to designs wherein few light-sensitive cells or only a single light-sensitive cell are involved. Thus, in the disclosure and in the claims hereinbelow, references to a “sensor” should be understood to apply also to a “camera” insofar as a digital camera comprises an array of individual sensors, and references to a “camera” should be understood to apply to a “sensor”, in that an electronic light sensor may be formed as the structural equivalent of a radically simplified camera.

In the discussion of the various figures described hereinbelow, like numbers refer to like parts.

The method and system presented herein comprise use of an own-light light source and a camera equipped with circuitry which reduces or cancels influence of ambient light on the camera, resulting in a photograph-based primarily on the own light supplied by the system.

Embodiments of the present invention comprise an own-light source and a camera or sensor. These embodiments temporally modulate own light supplied by the own-light light source, and also modulate light reception in the camera. Modulation of own-light sensitivity is coordinated with modulation of own-light supply in a manner which enhances light sensitivity to own-light and de-emphasizes light receptivity to other light not so modulated. Thus, in embodiments comprising a camera, modulation of camera sensitivity is coordinated with modulation in supplied own light in such a manner that the influence of own light reflected from a scene is emphasized in a photographic image produced by the camera, and light reflected from the scene originating from ambient sources and not so modulated, is de-emphasized in, or entirely eliminated from, the resultant photographic image.

Two general methods and systems are proposed. A first approach is referred to herein as “time based” or “time-domain” based. A second approach is referred to herein as “frequency based” or “frequency-domain” based.

In the “time-domain” approach, a timing modulation is introduced into the own light supply of light, and a corresponding timed modulation is introduced into the camera's receptivity to light. Coordination between timed supply of own light and timed changes in the receptivity of light receptors in the camera is used to distinguish between own light and ambient light, and in particular, to minimize sensitivity of light detection cells to ambient light while preserving sensitivity of those cells to own light.

In both time-domain and frequency-domain systems, own light is supplied in rapid timed pulses, preferably from rapidly switchable LEDs.

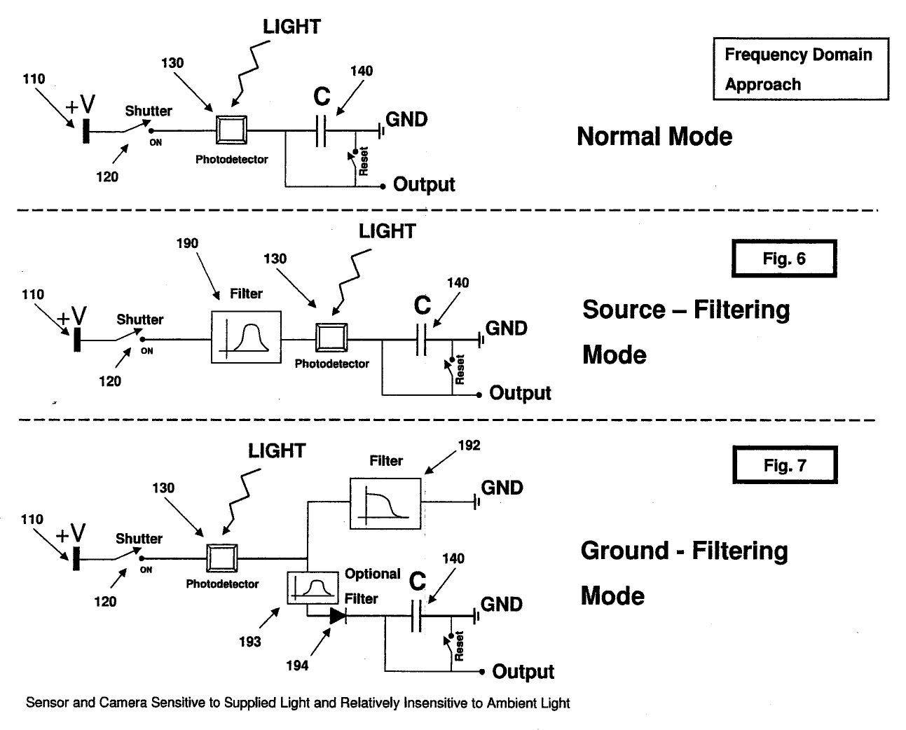

Light detection circuitry (e.g., in a video camera), typically comprises a voltage source and a frame-creating system comprising a shutter which delimits the exposure time (integration time), and sensor read out circuitry (typically CCD or CMOS circuitry), also responsive to a clock. In a typical interlaced camera, each frame comprises two fields, a first field presenting even-numbered pixels and a second field presenting odd-numbered pixels. For example, field time is 20 ms for the CCIR TV standard, and exposure time can vary automatically (or be fixed) from 20 ms down to 10 μs. For example, in the exemplary timing diagrams discussed below with reference to FIGS. 5, 8, and 9, a 20 ms field readout time and 10 ms exposure time (the equivalent of a 1/100 second shutter speed) are shown for the odd-pixel field.

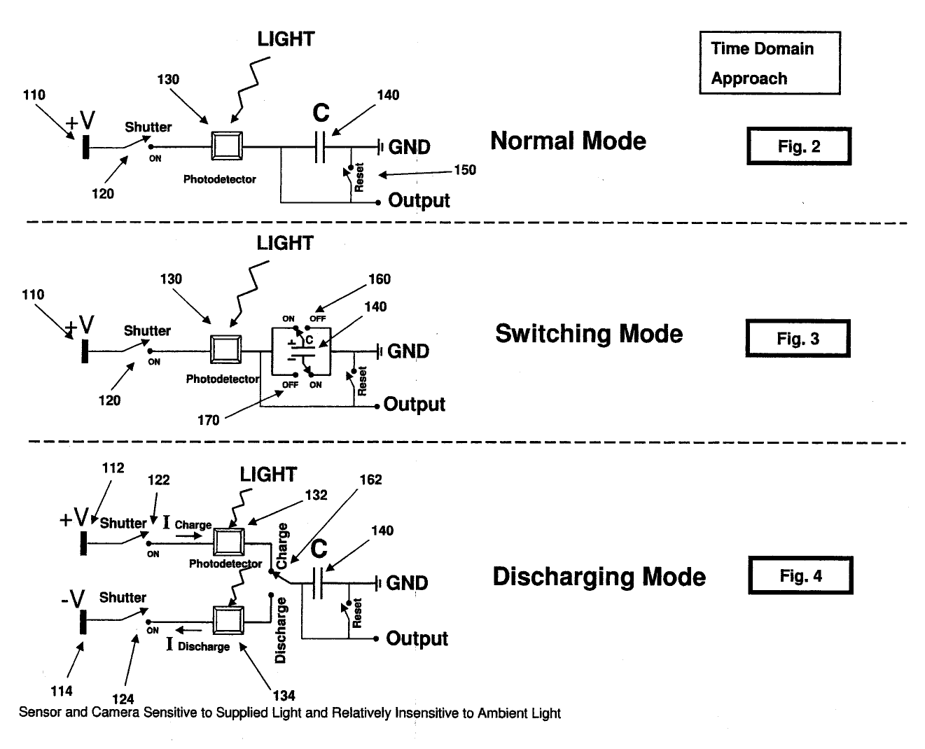

As is well known in the art, exposure of a next field typically occurs during readout of a previous field. Exposure is typically accomplished by intermittently connecting and disconnecting a voltage source through a light-sensitive sensor, which sensor is typically a photo-detector whose resistance varies with the amount of light to which it is exposed. The resultant current through the photo-detector charges a capacitor associated therewith. Thus, the amount of charge accumulated by each cell capacitor per unit of time is proportional to the amount of light to which the associated cell photo-detector is exposed. Construction of such a prior art system is discussed below with reference to FIG. 2.

In time-domain embodiments of the invention discussed in detail hereinbelow, camera light-detection circuitry is rapidly switched, each exposure time being divided into at least one first phase and at least one second phase. During first phases of operation, a capacitor is charged according to standard practice, as described in the previous paragraph, so that the amount of charge accumulated by the capacitor during first phases is dependent on the amount of light impinging on the photo-detector.

According to time-domain embodiments of the present invention, during second phases of operation, light-detection capacitor charged during first-phase operation is discharged, preferably by a reversal of direction of a charging current. Discharging current, passing either through the same photo-detector as that which controlled the charging current or through a second similar photo-detector, is similarly dependent on the amount of light impinging on that photo-detector

Timing of first and second phases and other parameters of the system circuitry are preferably chosen such that for a given cell the amount of charging during first phrase operation approximately equals the amount of discharging during second phase operation under constant lighting conditions.

Under time-domain embodiments of the present invention, timing of pulsed own light supplied by a light source controlled by the system is coordinated with timing of phase switching of a camera's light-detection circuitry, such that own light is switched ON during first phases of camera detection, and own light is switched OFF during second phases of camera detection.

During an individual exposure, usually lasting only a small fraction of a second, ambient light typically changes only slowly, if at all. Consequently, charging of each cell capacitor due to ambient light during a first phase operation is substantially counteracted by discharging of that cell capacitor during a second phase operation, thereby partially or wholly canceling out the influence of ambient light on the charging of each cell capacitor.

Own light, however, is switched on during first phases and switched off during second phases. Consequently, charging due to own light during first phases is not counteracted by corresponding discharging during second phases. Own light reflected from a scene being photographed contributes to charging of camera cells (pixels) during first phases of operation, but does not contribute to discharging of cell capacitors during second phases of operation.

Thus, cell capacitor charging due to ambient light during first phases is largely canceled out during second phases, yet cell capacitor charging during first phases due to own light is not canceled out during second phases. Light detection circuitry thus detects an image of a photographed scene as seen illuminated by own light, and largely ignores light information derived from ambient light.

Image interpretation problems resulting from large dynamic ranges of light intensities, often produced by photography in ambient light, described in the background section hereinabove, may be solved by switching camera circuitry between first phases and second phases multiple times per each frame exposure. Switching camera circuitry multiple times per exposure causes ambient light to ‘cancel itself out’ many times per exposure, thereby avoiding buildup of a large charge (or charge overflow) due to reflected sunlight or other bright ambient lights reflecting from a photographed object. Consequently, camera circuitry and physical parameters (e.g. gain, exposure time, lens opening), can be adjusted to operate in the dynamic range provided by reflected own light. A camera so adjusted is far more sensitive to subtle distinctions in an own-light-illuminated image than is a camera adjusted and optimized to encompass the dynamic light-intensity range presented by ambient light.

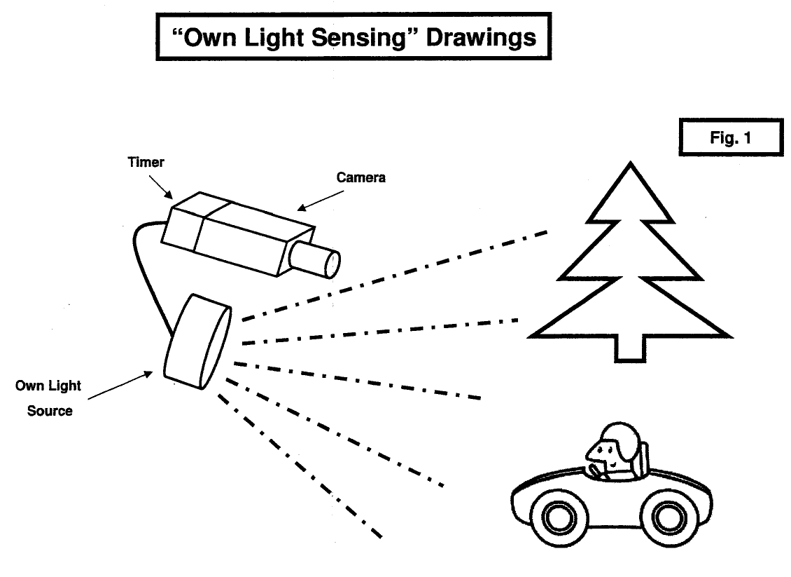

Referring now to FIG. 1, illustrating a simplified view of a photographic system 100, according to of the present invention, there is seen a camera (or sensor) 102, an own-light source 104, and a timer 106 usable to coordinate switching of both camera 102 and own-light source 104. As described above, timer 106 provides a timing signal used to coordinate supply of own light during phase one operation of camera 102 and non-supply of own-light during phase two operation of camera 102. Any timing coordination method operable to switch between the first and second phase operation of camera 102 in coordination of supply and non-supply of own light by own-light source 104, may be used.

FIG. 2, illustrates for comparison purposes, a prior art configuration of a light-sensitive charging apparatus such as is used in a cell (pixel) of a digital camera. Seen is a positive voltage source 110, a shutter 120, a photo-detector 130, a charging capacitor 140, a reset switch 150, and ground. As may be seen by viewing FIG. 2, when shutter 120 closes, completing a circuit, positive voltage is applied to a first side of capacitor 140, charging capacitor 140. Strength of the resulting charge on capacitor 140 depends on voltage 110, speed of shutter 120, and amount of light impinging on photo-detector 130.

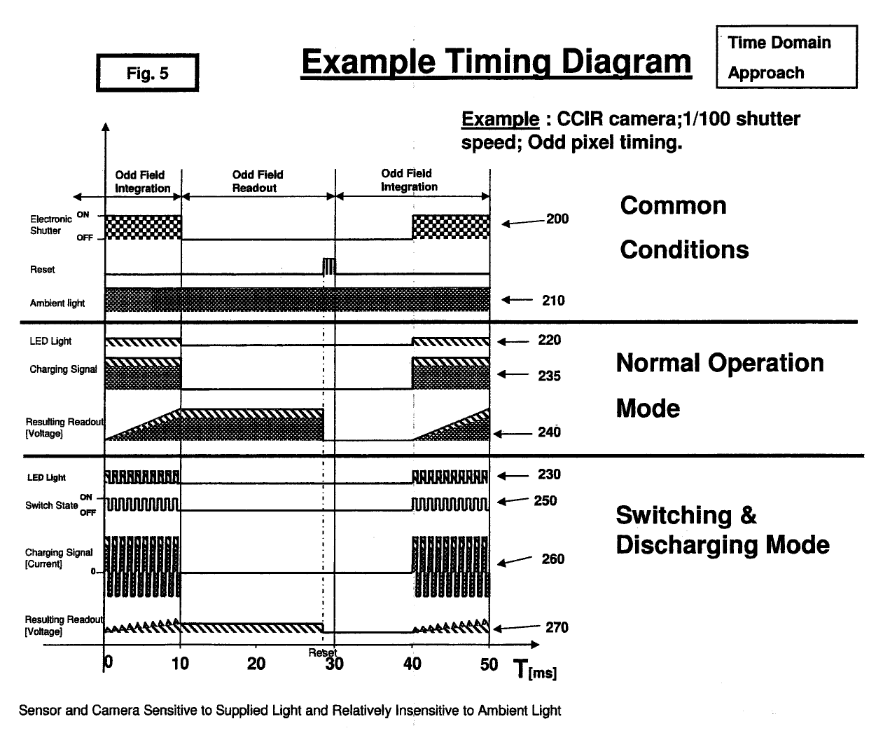

Referring now to FIG. 3, there is seen a simplified view of a cell 108 operable to charge cell capacitor 140 during first phase operation of cell 108 and to discharge capacitor 140 during second phase operations of cell 108, according to the present invention. In addition to elements illustrated in FIG. 2, switches 160 and 170, are depicted in their phase-one positions. With switches 160 and 170 positioned as shown, FIG. 3 is equivalent to FIG. 2, if shutter 120 is in its ‘on’ position, completing the circuit and capacitor 140 charges in an amount dependent on the amount of light reaching photo-detector 130. Transition to phase two operation is accomplished by switching switches 160 and 170 to their alternative positions. As may be seen from FIG. 3, with switches 160 and 170 in their alternative positions and shutter 120 closed, positive voltage will be applied to a second side of capacitor 140, thereby counteracting charge accumulated during first phase operation. Timing of phase one and phase two may be adjusted so that under constant ambient illumination and no own light, charge accumulated during phase one operation is exactly or nearly exactly removed by de-charging during phase two operation. If own light is supplied during phase one and not supplied during phase two, charge induced in capacitor 140 due to own light supplied during phase one, will substantially not be neutralized in capacitor 140 during phase two. Thus, charging of capacitor 140 due to ambient light is substantially neutralized, yet charging of capacitor 140 due to own light, is substantially not neutralized. A resulting non-neutralized charge remains in capacitor 140 at the conclusion of phase 2, and can be read by the camera cell's standard output mechanisms. (Standard output mechanisms are not shown in the Figure).

FIG. 4, which is a simplified schematic presenting an alternative construction of a cell operable to charge cell capacitor 140 during first phase operation and to discharge capacitor 140 during second phase operations, according to the present invention, illustrates cell 109 having first and second shutters 122 and 124 and first and second photo-detectors 132 and 134. Phase switch 162 is shown in its phase one position. With shutter 122 set to ‘on’ and phase switch 162 positioned as shown, capacitor 140 is connected to positive voltage source 112. This configuration charges capacitor 140, amount of charge being governed by photo-detector 132, as determined by the amount of light reaching photo-detector 132. For phase two operation, phase switch 162 is set to its “discharge” position, shutter 124 is turned on (i.e., its circuit is completed) and shutter 122 is turned off (i.e., its circuit is broken). With shutter 124 on, capacitor 140 is connected through light-sensitive photo-detector 134 to negative voltage source 114. Thus, phase two configuration serves to drain from capacitor 140 charges accumulated during phase one operation, the amount of drain determined by amount of light impinging on photo-detector 134. As with the configuration of FIG. 3, various parameters of the system may preferably be adjusted so that under only ambient light, amount of charge accumulated during phase one operation is approximately equal to amount of charge eliminated during phase two operation.

Configurations of FIGS. 3 and 4 are exemplary in purpose and not intended to be limiting. Other similar arrangements may be made for charging capacitor 140 during first phase operation and de-charging capacitor 140 during second phase operation. For any given arrangement, timing of phases one and two, and/or changes in applied voltages during phases one and two, may be adjusted so as to enhance optimization of the desired effect, namely that influence of ambient light on charging of capacitor 140 during phase one operation be counteracted during phase two operation, while charging of capacitor 140 due to own light supplied during phase one operation not be de-charged during phase two operation.

FIG. 5, which illustrates a timing diagram summarizing operation of an embodiment of the invention as described above, and contrasting it to the operation of prior art systems, depicts approximately 10 own-light pulses and 10 repetitions of phase-one/phase-two operation are shown per field. For simplicity, only odd-field operations are shown. In an interlaced camera, odd-pixel capacitors are charged while even-pixel capacitors are read, and vice versa)

Line 200 of FIG. 5 indicates operation of a shutter such as shutter 120. Ambient light is shown in line 210. A reset pulse is shown on line 205. Own light as might be supplied by prior art, is shown in line 220. (Of course, own light as supplied by prior art would in general be continuous. Only own-light relevant to charging of odd-frame pixels is shown in the Figure.) Prior art charging, showing charging due to ambient light combined with charging due to own light, is shown in line 235. The resultant prior art readout is shown in line 240.

In contrast, own light as supplied according to the present invention is shown in line 230. A phase timing signal is shown in line 250. A charging signal (e.g., a voltage used to charge and discharge a capacitor 140 as described) is shown in line 260. The resultant readout of the system, reflecting influence of own light illumination and absent influence of ambient light illumination, is shown in line 270. In practice, it may be difficult or impossible to entirely eliminate influence of ambient light. For practical purposes, a major reduction in the influence of ambient light, and an emphasizing of the influence of own light in an image, will render such an image far easier to interpret by human or automatic means than would be the equivalent image produced by ambient light, even if reduction of ambient light influence to zero is not accomplished.

A second general method for producing a light sensor or camera which is sensitive to system-supplied light and relatively insensitive to other light is now described. This second method is generally referred to herein as “frequency based” or “frequency-domain” based. It is to be noted that words “frequency” and “spectrum” as used herein and in the claims below, refer not to the frequency of light (the light wavelength, the color) but rather to frequencies of electronic events within an electronic system, such as frequencies of electric currents induced by electronic switching, or frequencies of electric currents induced by system responses to electronically switched light pulses.

The frequency-domain approach takes advantage of the fact that rapidly switched signals, such as electronic currents generated in a light sensor system in response to rapidly pulsed light, generate high-frequency harmonics. Harmonic frequencies of currents induced by rhythmically pulsing a voltage source can be calculated as a function of the frequency and waveform of the pulsed voltages. Thus, harmonic frequencies of charging currents presented by a camera shutter system may be calculated, as may the harmonic frequencies created in the detection apparatus, as it responds to light originating in a rapidly pulsing own-light light source. When waveforms (typically square waves) and frequencies of shutter pulses and of own-light pulses are appropriately chosen, harmonic frequencies induced by shutter switching can be made to be substantially different from harmonic frequencies induced in the detection apparatus as responses to light from a pulsing own-light source. A great portion of the spectrum of photocell charging signals due to own light can be made well separated from the spectrum of charging signals caused by ambient light, for example, by providing a switching rate of own-light supply which is substantially faster than the switching rate of a camera shutter system. Modulations other than square-wave pulsing can be used. Any modulation of own-light that can provide good separation between ambient and own-light induced current spectrums, can be used.

By appropriate choice of waveforms and frequencies of shutter pulses and of own-light pulses, currents induced by own-light rendered distinguishable from currents induced by ambient light according the differences in the frequency spectrums they induce in the detection apparatus. Once these spectrums are distinct, an appropriately designed frequency filter can be used to cause photosensitive cells of the camera be charged primarily under the influence of own light, and to be uninfluenced or less influenced by ambient light. In one embodiment, a frequency filter is use to preferentially pass to the charging apparatus frequencies strongly influenced by own light, thereby emphasizing own light contributions to the resulting image. In another embodiment, a frequency filter is used to ground a charging current at frequencies substantially uninfluenced by own light, thereby reducing influence of ambient light on the resultant image.

Thus, according to methods of frequency-filtering here presented, temporally modulated (and preferably rapidly switched) own light is directed towards an object being photographed, and camera circuitry is provided which selectively filters electronic frequencies induced in the light-detection apparatus, minimizing charge accumulation resulting from ambient light and maximizing charge accumulation resulting from time-modulated own light. Rate and waveform of own light modulation is selected in such a way that a significant portion of the electronic spectrum of the charging signal induced in light-sensor circuitry in response to reflected and refracted own-light received by that sensor, is well separated from the spectrum of the charging signal produced by ambient light interrupted by the standard shutter circuitry of the camera. In general, an own-light switching frequency much higher than the camera shutter switching frequency will be selected, leading to multiple strong high-frequency harmonics induced in the sensor circuitry in response to own light.

In a preferred embodiment, an electronic filter is used to ground portions of signal spectrum primarily caused by ambient light, thereby relatively emphasizing detection of portions of signal spectrum primarily caused by own light. In an alternative preferred embodiment, high-frequency signals primarily induced in response to own light are passed to a charging capacitor, while lower frequency signals heavily influenced by ambient light are at least partially blocked from charging that capacitor, again resulting in a capacitor charge preferentially influenced by own light and relatively less influenced by light from other sources.

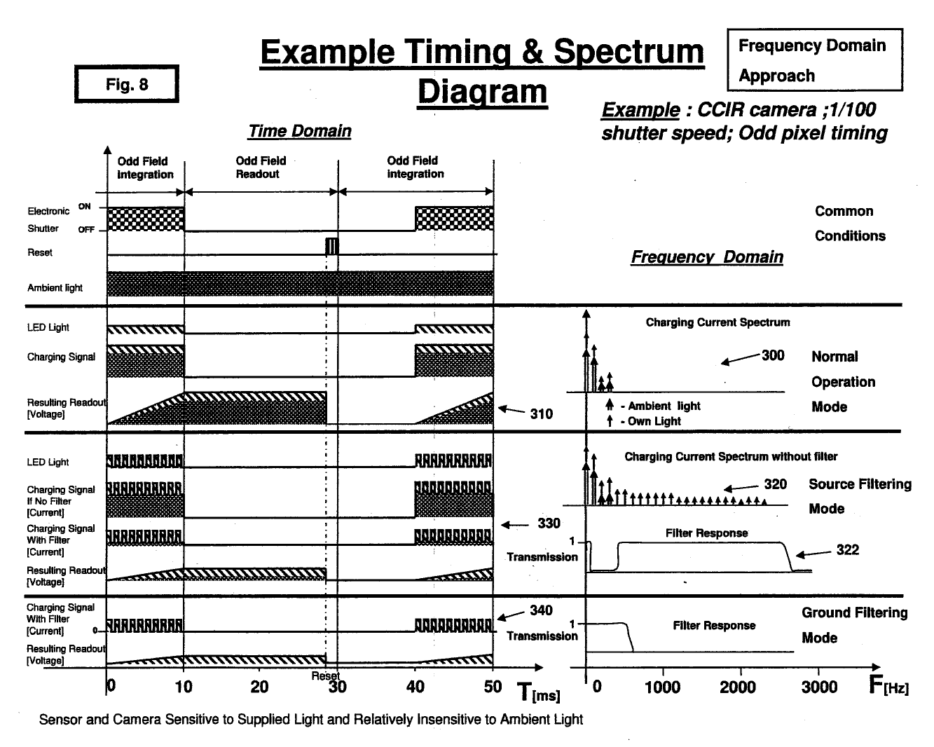

FIG. 6, which is a simplified schematic of light-sensitive system using frequency filtration to emphasize sensitivity rapidly modulated own light and to de-emphasize sensitivity to ambient light, according to an embodiment of the present invention, illustrates a light-sensitive system 111, e.g., a pixel cell of a digital camera, which is similar to the prior art cell presented in FIG. 2, except for presence of filter 190. Filter 190 filters cell 111's driving signal, blocking charge flow at frequencies induced by ambient light, and allowing charge flow to capacitor 140 at frequencies induced by own light. An important advantage of system 111 is that filter 190 may be used in common by a plurality of pixel cells connected in parallel to filter 190, vastly simplifying implementation of system 111 in a digital camera.

FIG. 7 is a simplified schematic of an alternative construction of a light-sensitive system, labeled system 113, using frequency filtration to emphasize sensitivity rapidly modulated own light and to de-emphasize sensitivity to ambient light, according to present invention. The photo-detector accumulation current is grounded through a frequency filter 192 during the accumulation time. Filter 192 has a pass spectrum which passes, to ground, relatively low-frequency current generated in response to ambient light. Filter 192 also tends to block high frequencies, particularly harmonics generated in system 113 in response to rapidly switched own light. As a result, at least a portion of charge signal based on ambient light is grounded, thereby causing capacitor 140 to accumulate charge primarily resulting from own light. An additional optional filter 193 may be provided between photo-detector 130 and capacitor 140, to further filter out frequencies of ambient light charging current, permitting passage of higher-frequency currents resulting from own light to charge capacitor 140. Diode 194 is provided to prevent leakage from capacitor 140, which must retain its charge until readout occurs.

In frequency filtration systems such as 111 and 113, coordination between on/off switching of own light supply 102 and on/off switching of phases of operation within camera/sensor 102 is not required, since own light, modulated at a high frequency, can be supplied continuously, frequency filtering within circuits of camera 102 serving to facilitate charging due to own light and to hamper charging due to ambient light. Thus, common timer 106 is not required for operation of systems 111 and 113 and similar systems.

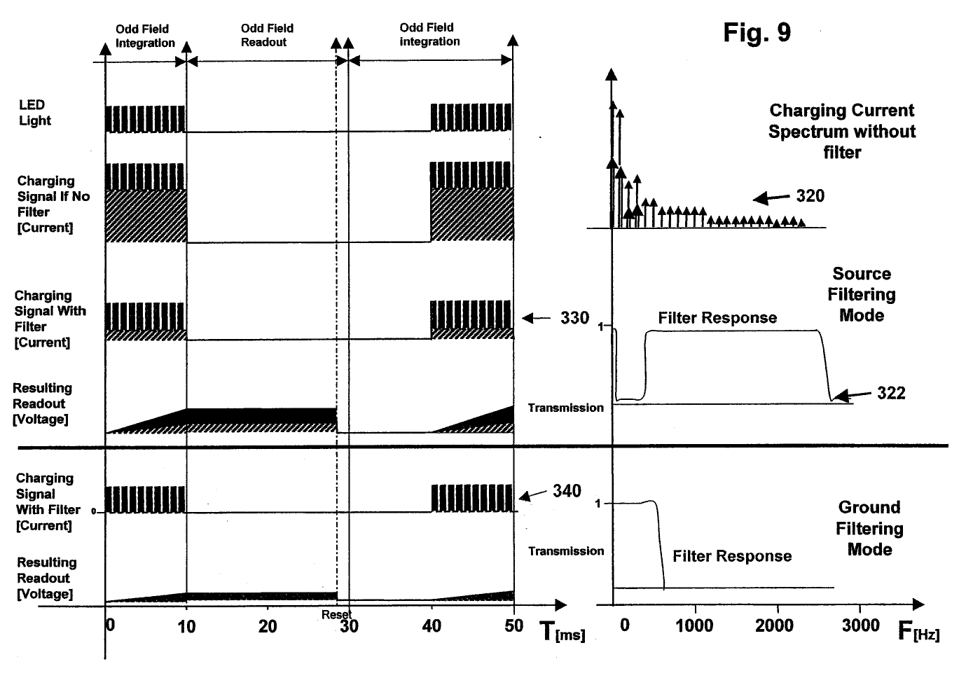

Referring to FIG. 8, which is a timing and spectrum diagram presenting various aspects of functionality of systems of prior art, and to FIG. 9 which is a timing and spectrum diagram presenting various aspects of functionality of 111 and 113 and similar systems, according to the present invention, under prior art conditions, a charging current spectrum 300 created by switching of the charging current at shutter 120 is unfiltered, so that charge due to ambient light and charge due to own light are undifferentiated and collectively charge capacitor 140, as shown in line 310 of FIG. 8. When own light is switched on and off rapidly (as compared to the switching speed of shutter 120), an additional current spectrum is created, as shown at 320 of FIG. 9, which spectrum includes various high frequencies substantially induced by own-light-driven switched charging current.

Charging resulting from filtering by filter 190 of FIG. 6, blocking low frequencies, and thereby substantially blocking current not due to the high-frequency switching of the own-light-driven charging current, produces the charging current shown at line 330 of FIG. 9, where a component due to own light is proportionally greater because components not due to own light have been substantially blocked.

Charging resulting from filtering by filter 192 of FIG. 7 is shown in line 340 of FIG. 9, where low frequency charging currents are passed to ground through filter 192, leaving only higher frequencies, those frequencies induced by the higher frequency switching of own-light-driven charging current, to charge capacitor 140.

Filtering which distinguishes low from high frequencies in the detection circuit can be sufficient to distinguish ambient-light-induced currents from own-light-induced currents. While a rectangular pulse has a spectrum of a “sinc” function i.e., sin(x)/x (where x=πfT; T=pulse width. f=frequency), a repeating rectangular pulse has a spectrum of “sinc” but sampled at the frequency of the repetition frequency. Therefore, in the example shown in FIG. 8 (where no filter exists and the shutter is opened for 10 ms every 40 ms, a rectangular current pulse of 10 ms every 40 ms will be induced. This shutter-induced current has a spectrum of sin(πfx10 ms)/(πfx10 ms), sampled at sampling frequency Fₛ= 1/40 ms, that is, sin(πf/100 Hz)/(πf/100 Hz) sampled every 25 Hz. The own-light is shown in FIG. 9 with a pulse width of 10 ms/20=0.5 ms, and a repetition period of 1 mS. The current induced by own light will have a spectrum of sin(πf/2000 Hz)/(πf/2000 Hz) sampled every 1 kHz, convoluted with the spectrum of the shutter, since own light induces current only when the shutter is ON (multiplication of the two signals in the time domain implies convolution in the frequency domain). Of course, there is an overlapping of spectrums of own light and of ambient light, but as may be seen from FIG. 9 (comparing area 300 of FIG. 8 to area 320 of FIG. 9), the ambient light spectrum decreases about 20 times faster than the own-light spectrum, so a good separation exists in the frequency domain. Using a high-pass filter to filter out frequencies below, say, 300 Hz, will decrease the charging caused by the ambient light very significantly while influencing the own-light-induced current only slightly. Increasing the own light modulation frequency beyond that shown in FIG. 9 will enable even better separation.

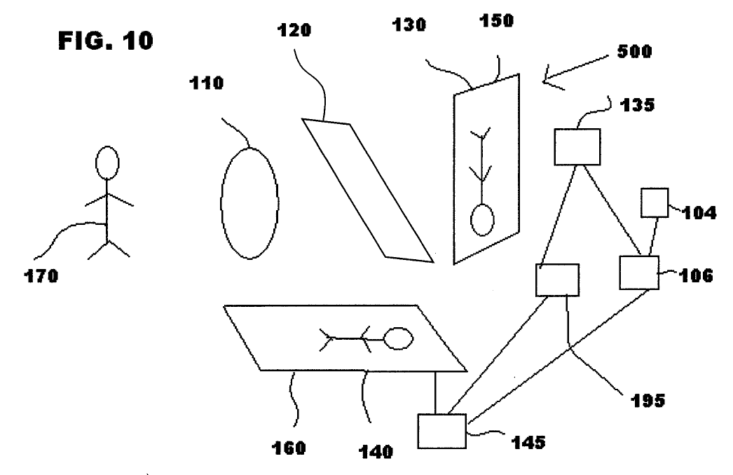

FIG. 10, which is a simplified schematic of a system using a partially silvered mirror to produce photographs sensitive to system supplied light and relatively insensitive to other light, according to the present invention, may be advantageously constructed using standard or nearly-standard parts, and hence can be implemented relatively easily and inexpensively. Illustrated in FIG. 10 is a system 500 in which a first pixel array 130 and a second pixel array 140 are exposed to focused image of a same scene 170. System 500 comprises a lens 110, a partially silvered mirror 120, a first pixel array 130 and a second pixel array 140. Module 135 represents the ensemble of electronic support for pixel array 130, and module 145 represents the ensemble of electronic support for pixel array 140. Modules 135 and 145 are not described in detail as they are intended to represent standard CCD and/or CMOS and/or similar photography technologies known in the art. Pixel array 130 with its supporting module 135 works just like a typical electronic camera, i.e., an image is focused by lens 110 through partially silvered mirror 120 onto pixel array 130, and module 135 provides shutter timing and image readout in the usual manner. In other words, lens 110, pixel array 130 and support module 135 constitute a first camera unit 150. First camera 150 sees scene 170 through partially silvered mirror 110 by transparence of mirror 110. Scene 170, focused by lens 110, is also reflected by mirror 110 onto second pixel array 140. Thus, lens 110, mirror 120, pixel array 140 and supporting module 145 constitute a second camera unit 160. Array 130 is positioned so that image 170, transmitted by mirror 110 is focused by lens 110 onto image 130, and array 140 is positioned so that image 170, reflected by mirror 120, is focused on array 140. Thus, with all elements positioned correctly, array 130 and array 140 are exposed to substantially a same image.

Following the general principles discussed above and in particular with reference to FIGS. 1 and 3 to 5, it may be noted that if first pixel array 130 is active in light detection during first periods and a second pixel array 140 is active in light detection during second periods, and illumination of scene 170 by own-light light source 104 is supplied during first periods and not supplied during second periods, then analog or preferably digital methods may be used to subtract the charge on capacitors of second pixel array 140 from capacitors of first pixel array 130 to produce a pixilated readout substantially reflecting own-light illumination only.

Such a solution is disadvantageous in that it does not solve the problem of large dynamic range input (the “wash out” problem discussed in the background section), but it is advantageous in that it may be implemented in a manner which does not necessitate modifications of intra-camera electronic hardware.

A timing signal source 106 provides a shutter timing signal to camera unit 150 through module 135, and to camera unit 160 through module 145. Timing signal source 106 also provides a timing signal to own-light provider 104, which provides own-light for illuminating scene 170. Timing signal source 106 may be any arrangement which provides coordinated timing among the two camera units and own-light source 104, such that the shutter of camera unit 150 is open, i.e., accumulating charge, during first phases times, when own-light is supplied, and closed during second phase times, and the shutter of camera unit 160 is open during second phase times when no own-light is supplied, and closed during first phase times. A readout system 195 is provided to subtract the charge readout from pixel array 130 of camera unit 160 from the charge readout of pixel array 140 of camera unit 150, and to report the difference, which difference, an array of pixel values, is the own-light image.

Thus, to summarize FIG. 10, a photography system is provided responsive to illumination supplied by said system and less responsive to other light, comprising:

(a) a system-controlled light supply;

(b) a first pixel array of light sensors and a second pixel array of light sensors;

(c) an optical arrangement which comprises a partially silvered mirror and lens, said optical arrangement serving to focus an image of a scene on both the first pixel array and the second pixel array;

(d) a timing system serving to coordinate operation of the system such that during first phases of operation the first pixel array is charged and the second pixel array is not charged, and during second phases of operation the second pixel array is charged and the first pixel array is not charged, and the light supply supplies light during said first phases and does not supply light during said second phases, and

(e) a calculation module operable to calculate a pixilated image based on the differences of charges between the second array and the first array.

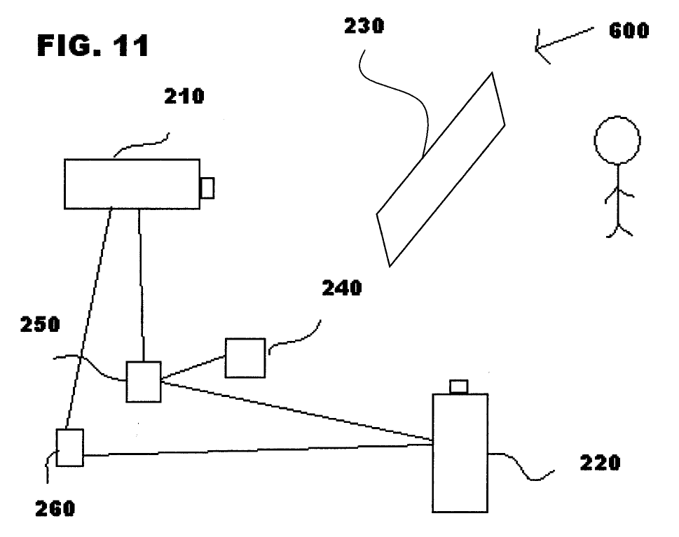

FIG. 11, which is a simplified schematic of an alternative construction of a system using a partially silvered mirror to produce photographs sensitive to system supplied light and relatively insensitive to other light, according to an embodiment of the present invention, provides a system 600 similar to system 500 with a slightly different configuration of components. System 600 comprises a first camera 210, a second camera 220, a partially silvered mirror 230, an own-light source 240, a timing coordinator 250, and a differencing and reporting module 260. System 600 functions as described above for system 500, with timing coordinator providing timing signals to cameras 210 and 220 and to own-light source 240 as timing signal source 106 provides timing signals to camera units 150 and 160 and to own-light source 190, and differencing and reporting module 260 subtracting pixel values reported from camera 220 from those reported from camera 210 and reporting the difference as an own-light image. A principle difference between system 500 and system 600 is that lens 110 is used in common by two camera units in system 500, whereas each of cameras 210 and 220 has its own lenses and focusing apparatus in system 600. System 500 is, of course, potentially more efficient in terms of costs of components. System 600 has the advantage that it can be implemented using standard “off the shelf” commercial cameras, requiring only a minor modification required to coordinate timing of the shutters of cameras 210 and 220 and of own-light source 240 as described. Differencing and reporting module 260 may be implemented as a hardware component, or may be embodied as software running on a computing unit such as a PC computer which receives standard output signals from cameras 210 and 220, and subtracts one pixel array from the other to report the difference, which is the own-light image provided by system 600. It may be noted that implementation of system 600 does not actually require exact line-up of cameras 210 and 220, though exact lineup is of course preferable. Alternatively, in an initial setup procedure system 600 may be directed to a target scene and a human operator or automatic system can be used to identify specific scene objects in images reported by cameras 210 and 220, thereby identifying which pixels in camera 220 are aligned with selected pixels of camera 210. That alignment, once established, can be the basis determining what pixel set of camera 220 is to be subtracted from a selected pixel set of camera 210 during system 600 operation.

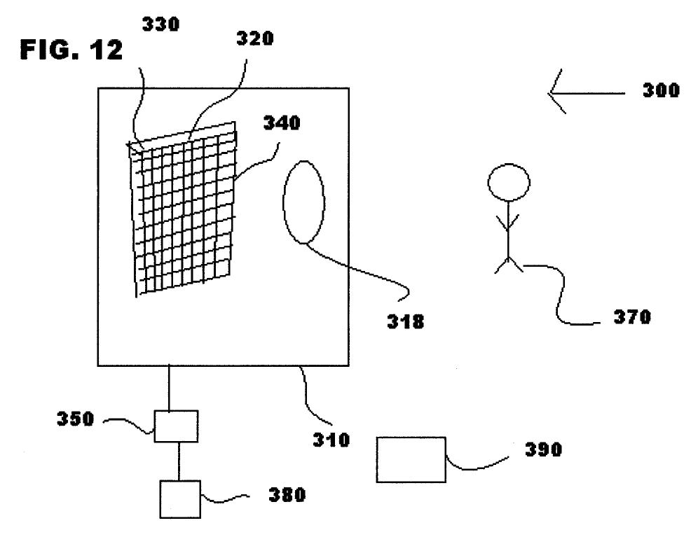

FIG. 12, which is a simplified schematic of a system using an interleaved camera to produce photographs sensitive to system supplied light and relatively insensitive to other light, according to the present invention, provides an additional embodiment which is relatively easy to implement. In a typical interlaced digital camera in current use, each frame comprises two fields, a first field presenting even-numbered pixels and a second field presenting odd-numbered pixels. In a typical interlaced camera, readout of accumulated charge on even-field pixels occurs while odd-field pixels are accumulating charge, and then the accumulated charges of the odd-field pixels occurs while even-field pixels are accumulating charge. Thus, the even-field pixel array and the odd-field pixel array of a single standard interlaced camera present nearly-identical pixel arrays, whereon are focused, through a common lens, nearly identical images of a scene. FIG. 12 illustrates a system 300 which comprises an interlaced camera 310 wherein a common lens 318 focuses an image of scene 370 on a pixel array 320. Pixel array 320 comprises pixels of a first pixel field 330 interlaced with pixels of a second field 340. Typically, first field 330 will be even-numbered pixels and second field 340 will be odd-numbered pixels, or vice-versa. A timing coordinator 350 coordinates timing between electronic shutter mechanisms of camera 310 and an own-light source 380, such that own-light is supplied during charge accumulation of first field 330 and is not supplied during charge accumulation of second field 340. A differencing and reporting module 390 is provided to subtract second-field pixel values from first-field pixel values, thereby generating an own-light image.

Own-light being supplied during even-field pixel charge accumulation and not being supplied during odd-field pixel charge accumulation, it is possible to derive a nearly-exact own-light image by subtracting the pixel charge values of odd-field pixels from the charge values of adjacent even-field pixels from a same camera. Similarly, if own-light is supplied during odd-field pixel charge accumulation and own-light is not supplied during even-field pixel charge accumulation, it is possible to derive a nearly-exact own-light image by subtracting the pixel charge values of even-field pixels from the charge values of adjacent odd-field pixels from a same camera.

Of course, the image match between even and odd pixels will not be wholly exact. For one thing, adjacent even and odd pixels are slightly displaced, horizontally and often vertically as well. For another thing, there is a temporal, as well as a spatial displacement between the two fields, since one field accumulates charge while the other is being read out, and vice-versa, consequently the two arrays will present slightly different images if photographing a scene which includes a moving object, or if the camera system itself is moving. Nevertheless, for some applications, these minor displacements will not be significant, or may be rendered insignificant by appropriate software manipulation of the acquired data. Thus, module 390 may include algorithms for eliminating or reducing noise introduced by the displacements mentioned above. For example, edge effects will be created when subtracting second field pixels from first field pixels, when the photographed scene includes bright objects on dark backgrounds, or dark objects on bright backgrounds. However, these edge effects will typically be only one pixel wide, and module 390 can be programmed to ignore (i.e., to eliminate) sharp differences appearing in the own-light image, when those differences are only one pixel wide. Similarly, differences introduced by timing displacement may, for some applications, be predictable. In photographing, for example, slow moving objects in a regular setting, it may be possible to roughly predict amount and direction of displacement of a photographed object between a first-field image and a second-field image, and module 390 may be programmed to compensate by selecting an appropriate set of second-field pixels to subtract from a given set of first-field pixels when calculating an own-light image.

In any case, for a wide variety of applications, noise caused by the displacements mentioned in the preceding paragraph may be of minor importance and/or be able to be minimized by appropriate software or firmware manipulation of the acquired images. A typical example is in the photography of retro-reflective numbers and letters on license plates of non-moving or very slow-moving vehicles. Since the numbers and letters are retro-reflective, they provide a strong reflection into a camera when photographed by own light supplied from a position near that camera. The images of numbers and letters from the license plate when so photographed are typically at least several pixels wide, consequently programming module 390 to ignore narrow (e.g., single-pixel) edge effects in own-light images and will not damage the readability of the numbers and letters of the photographed license plates.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A light-sensitive system responsive to light supplied by said system and less responsive to other light, comprising:
a) a light source operable to supply time-modulated illumination, and
b) a light sensor having greater response to said time-modulated illumination than to light from other sources.

2. The system of claim 1, further comprising a plurality of said light sensors.

3. The system of claim 2, wherein said plurality of light sensors is embodied as an array of pixels.

4. The system of claim 3, wherein said array of pixels is embodied as a digital camera.

5. The system of claim 1, wherein said light sensor comprises a capacitor and is so constructed that measurement of accumulated charge of said capacitor occurs periodically at a first rate, said light source is operable to be periodically switched on and off and a second rate, and said second rate is faster than said first rate.

6. The system of claim 1, wherein said light sensor comprises a capacitor, light-detection circuitry of said sensor is operable to charge said capacitor during first periods and to de-charge said capacitor during second periods, and said light source is operable to supply light during said first periods and to not supply light during said second periods.

7. The system of claim 1, wherein said sensor comprises a frequency bypass filter.

8. The system of claim 7, wherein said filter preferentially passes high frequencies and blocks low frequencies.

9. The system of claim 7, wherein said filter preferentially passes low frequencies and blocks high frequencies.

10. The system of claim 7, further comprising a frequency filter operable to preferentially pass to a charging apparatus of said light sensor harmonic frequencies generated in response to rapidly switched light from said light source, while at least partially restricting passage of currents having frequencies lower than said harmonic frequencies.

11. The system of claim 7, further comprising a frequency filter operable to ground currents induced by light switched at frequencies inferior to harmonic frequencies generated in response to rapidly switched light from said light source, thereby reducing influence of ambient light on said sensor.

12. A photography system responsive to light supplied by said system and relatively unresponsive to other light, comprising:
a) a light source operable to supply time-modulated illumination to a scene, and
b) a camera having modulated sensitivity to light, said time-modulation of said supplied light being so coordinated with said modulated light sensitivity that said camera is relatively more sensitive to said time-modulated light than to other light not so modulated.

13. The system of claim 12, wherein said modulated sensitivity to light is time modulated.

14. The system of claim 12, wherein said modulated sensitivity to light is frequency modulated.

15. A method for photographing an object as illuminated by a controlled light source and at least partially ignoring ambient light illuminating said object, comprising:
a) providing a time-modulated controlled light source and a camera comprising at least one light-sensor which comprises a capacitor;
b) charging said capacitor during first periods and de-charging said capacitor during second periods, and
c) providing light from said time-modulated controlled light source during said first periods and not providing light from said time-modulated controlled light source during said second periods.

16. A method for photographing an object as illuminated by a controlled light source and for at least partially ignoring ambient light illuminating said object, comprising:
a) providing a time-modulated controlled light source modulated at a first frequency and a camera comprising at least one light-sensor having electronic circuitry which comprises a capacitor, said camera being operable at a frame rate slower than said first frequency, and
b) utilizing a frequency filter to selectively facilitate charging of said capacitor by high frequencies and hinder charging of said capacitor by low frequencies, thereby facilitating charging of said capacitor by frequencies induced in said circuitry in response to light supplied by said time-modulated light source and hindering charging of said capacitor by frequencies not induced in said circuitry by light supplied by said time-modulated light source.

17. A photography system responsive to illumination supplied by said system and less responsive to other light, comprising:
a) a system-controlled light supply;
b) a first pixel array of light sensors and a second pixel array of light sensors;
c) an optical arrangement which comprises a partially silvered mirror and lens, said optical arrangement serving to focus an image of a scene on both said first pixel array and said second pixel array;
d) a timing system serving to coordinate operation of said system such that during first phases of operation said first pixel array is charged and said second pixel array is not charged, and during second phases of operation said second pixel array is charged and said first pixel array is not charged, and said light supply supplies light during said first phases and does not supply light during said second phases, and
e) a calculation module operable to calculate a pixilated image based on charge differences between said second array and said first array.

18. A photography system responsive to illumination supplied by said system and less responsive to other light, comprising:
a) an interleaved digital camera having a pixel array which comprises first and second sub-arrays of pixels;
b) a light source;
c) a timing mechanism operable to coordinate supply of light from said light source and frame rate of said interleaved camera in such manner that light is supplied by said light source during charging of said first sub-array of pixels and light is not supplied from said light source during charging of said second sub-array of pixels, and
d) a calculation module operable to calculate a difference image based on differences between charges of pixels of said first sub-array and charges of pixels from said second sub-array.

19. A method for producing an photographic image of a scene as illuminated by a controlled light source, comprising focusing an image of said scene on a first pixel array and on a second pixel array, illuminating said scene by said controlled light source during charging of said first pixel array, not illuminating said scene during charging of said second pixel array, and calculating a difference image representing an array of differences between charges of said first array and charges of said second array.

20. The method of claim 19, further comprising focusing said image of said scene on a first pixel array and on a second pixel array by utilizing a partially silvered mirror to direct some light of said image to said first pixel array by transparence through said mirror and to direct some light of said image to said second pixel array by reflection from said mirror.

21. The method of claim 19, wherein said first pixel array is a first pixel sub-array of a pixel array of an interleaved camera and said second pixel array is a second sub-array of a pixel array of said interleaved camera.
